(19) United States
(12) Patent Application Publication
(10) Pub. No.: US 2009/0322686 A1
(43) Pub. Date: Dec. 31, 2009

(54) Control And Navigation For A Device Implementing a Touch Screen

(76) Inventor: Parakrama Jayasinghe, Rajagiriya (LK)

Correspondence Address: MOTOROLA, INC., 1303 EAST ALGONQUIN ROAD, IL01/3RD, SCHAUMBURG, IL, 60196, US

(21) Appl. No.: 12/145,797

(22) Filed: Jun. 25, 2008

(51) Int. Cl. G06F 3/041

(52) U.S. Cl. 345/173; 178/18.03

(57) ABSTRACT

Described is a method which includes the following steps: detecting an input into a touch screen; detecting the release of the input from the touch screen; calculating an elapsed time between the input and the release of the touch screen; and activating a function based on the elapsed time. Described is also a device. The device includes a memory storing a plurality of functions and a corresponding time interval for each function; a tactile input detecting an activation and a release; a timer determining an elapsed amount of time between the activation and the release of the tactile input; and a processor activating one of the plurality of functions based on the elapsed time and the corresponding time interval.

### FIELD OF INVENTION

The present application generally relates to systems and methods for control and navigation on a device implementing a touch screen. Specifically, the exemplary system and methods may allow a user of a device, such as a hand-held mobile phone, to activate defined shortcuts after touching a touch screen.

### BACKGROUND

Touch screen based devices have become increasingly popular. As a result cell phone manufacturers are releasing more and more devices that are mostly, or all, touch screen based, having few, if any, tactile buttons. To operate the device a user is required to hold the device in one hand and use the other hand to point to a particular function on the screen. Operation of the device can become complicated since it can be hard to press a small, specifically defined, area on the screen. Many functions become difficult to perform since a user may be required to enter deep in the programming of the device, using multiple presses of different predefined areas on the screen. Single-handed operation, in particular, is particularly cumbersome since it is difficult to hold a device and touch a specific, on screen, button with a person's thumb.

### SUMMARY OF THE INVENTION

The present invention relates to a method which includes the following steps: detecting an input into a touch screen; detecting the release of the input from the touch screen; calculating an elapsed time between the input and the release of the touch screen; and activating a function based on the elapsed time.

The present invention also relates to a device which includes a memory storing a plurality of functions and a corresponding time interval for each function; a tactile input detecting an activation and a release; a timer determining an elapsed amount of time between the activation and the release of the tactile input; and a processor activating one of the plurality of functions based on the elapsed time and the corresponding time interval.

### BRIEF DESCRIPTION OF THE DRAWINGS

FIG. 1 shows an exemplary embodiment of a mobile device according to the present invention.

FIG. 2 shows an exemplary method 200 for activating shortcut operations on a device implementing a touch screen.

### DETAILED DESCRIPTION

The exemplary embodiments of the present invention may be further understood with reference to the following description and the related appended drawings, wherein like elements are provided with the same reference numerals. The exemplary embodiments of the present invention are related to systems and methods for enabling the activation of a shortcut on a device implementing a touch screen. Specifically, the system and methods may allow a user of a device, such as a hand-held mobile device, to hold down a button or area on the phone, for predetermined intervals, to activate defined shortcuts. The shortcuts may be predefined by the manufacturer or customizable by the user. The exemplary embodiments of the present invention may be easily implemented into a device using the existing user interface software components and small modifications to a driver software layer. Accordingly, there is no need for additional hardware resources to be in operation. The exemplary embodiments are described with reference to a mobile device, but those skilled in the art will understand that the present invention may be implemented on any device including a touch screen.

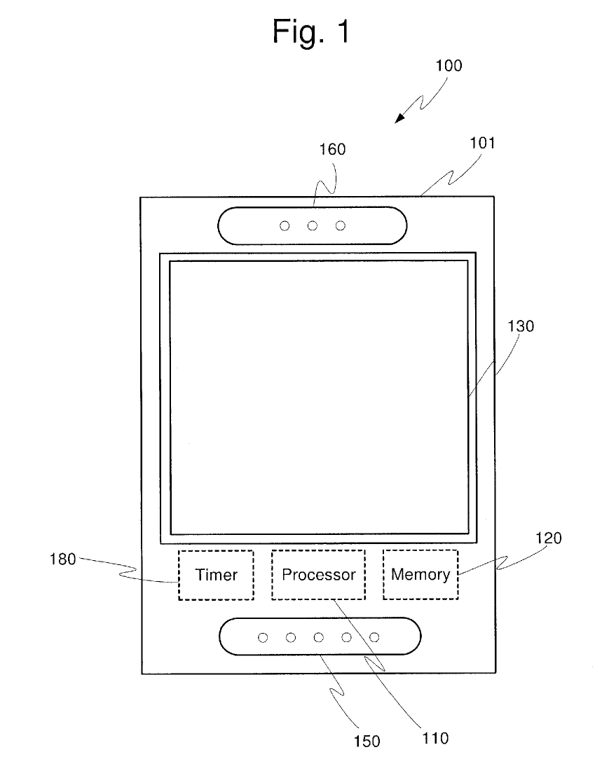

FIG. 1 shows an exemplary system 100 for activating defined shortcuts on an electronic device, such as Mobile Unit (“MU”) 101. FIG. 1 shows a block diagram view of the handheld MU 101 (e.g., a mobile telephone) according to the present invention. The MU 101 may include a processor 110, a memory 120, a touch screen 130, a microphone 150, a speaker 160, and a timer 180. Those skilled in the art will understand that the components illustrated for the MU 101 are only exemplary and that a MU implementing the present invention may have additional components or some of the illustrated components may not be included.

According to the exemplary embodiments of the present invention, the processor 160 may regulate the operation of the MU 101 by facilitating the communications between the various components of the MU 101. For example, the processor 160 may include a microprocessor, an embedded controller, a further application-specific integrated circuit, a programmable logic array, etc. The processor 160 may perform data processing, execute instructions and direct a flow of data between components coupled to the processor 160 (e.g., the memory 120, the touch screen 130, etc.). As will be explained below, the exemplary processor 160 may receive a signal from timer 180 to execute defined shortcuts depending on the time elapsed during touch screen input.

As will be described in greater detail below, the user of the MU 101 may activate a predefined shortcut in dependence on an amount of time a user continuously engages the touch screen 130. After the touch screen 130 is activated (e.g., with the user's finger) the timer 180 is activated. When the user releases the touch screen 130, the timer 180 sends the elapsed amount of time to the processor 110. The processor 110 then activates a predefined shortcut in dependence on the amount of time that the user continued to engage the touch screen 130 as counted by the timer 180. Furthermore, as described below, different audible, tactile, or visual cues can be used to designate the passage of each time interval to the user. The activated shortcuts may be predefined by the MU manufacturer or user customizable. It should be noted that the shortcuts are not limited to only being predefined by the manufacturer, or user customized; the list of shortcuts activated may be a combination of both predefined and user customized.

According to exemplary embodiments of the present invention the touch screen 130 detects an input from the touching of the screen (e.g., a user pressing their finger on the screen). The touching may occur on a specific button displayed by the touch screen 130 or in a specific location of the touch screen 130. The touch screen 130 sends the detection of an input to the processor 110, which starts the timer 180. It should be noted that while the timer 180 is shown as a separate component, it may also be a portion of another component such as the processor 110 or it may also be a software timer executed by the processor 110. The timer 180 starts counting and sends the timer information to the processor 110 (e.g., as various time periods expire). The touch screen 130 also detects the discontinuation of an input into the touch screen 130 (e.g., the user removes their finger from the screen). The touch screen 130 sends the discontinuation to the processor 110, which communicates with the timer 180 to determine the amount of time elapsed since an input was detected on the touch screen 130. The processor 110 then activates a shortcut based on the amount of time elapsed between the activation and deactivation of an input into the touch screen 130. The shortcuts activated may be predefined by the manufacturer of the MU 101. For example, shortcut one may be to display a list of available contacts, shortcut two may activate text messaging, and shortcut three may activate picture messaging. It should be noted, however, that the predefined shortcuts are not limited to the shortcuts used above and any shortcut, or number of shortcuts, may be predefined, limited only by the available functions the MU 101 can perform. Furthermore, the order of the shortcuts may be in any order determined by the manufacturer of the MU 101. In a further embodiment the shortcuts may be selected by the user. The user, in a setup menu, may select which shortcuts they want available to be activated during the timing process. The user may specify which shortcuts to use, and at what time interval each shortcut is activated.

The touch screen 130 may be any type of touch screen, such as a contact touch screen or a heat sensitive touch screen. In a contact touch screen a stylus type device is used to activate the input into the touch screen 130. A stylus is typically a pen-like device, without the capability to write on paper, which acts as the input device into the contact touch screen. It should be noted however, that the touch screen 130 input is not limited to a stylus device and can be any other device used to activate a contact touch screen.

In a heat sensitive touch screen the MU 101 uses the heat generated from an object (e.g., a finger) to determine contact with the touch screen. When the touch screen detects the absence of heat, after first detecting the presence of heat, the touch screen determines that contact is no longer being made with the touch screen. It should be noted that while examples of a contact touch screen and a heat sensitive touch screen are described herein there could be other methods to determine contact with the touch screen 130, which include, but are not limited to the combination of a contact and heat sensitive touch screen.

In a further exemplary embodiment the touch screen 130 may be divided up into separate areas or display multiple buttons. For example the touch screen 130 may be divided into four quadrants. When the user presses a certain quadrant of the touch screen 130 a different signal, representative of which quadrant was activated, is sent to the processor 110. The processor 110 then activates the timer 180. When a user removes contact from that particular quadrant, a specific shortcut is activated. Each quadrant, or button, may have different shortcuts, which are activated, and may utilize different time intervals. It should be noted, however, that while quadrants are used as an example, the above embodiment is not limited to quadrants and the touch screen 130 may be divided up into any number of different combinations.

According to an exemplary embodiment of the present invention, the speaker 160 may be in communication with the processor 110. The process 110 may instruct the speaker 160 to emit a predetermined sound based on the elapsed time from the timer 180. The volume of the speaker 160 can be set by the user and can be raised to be audible without the need for the user to place the MU 101 next to the user's ear. The speaker 160 emits a predefined sound based on the elapsed time from the timer 180. At specific intervals corresponding to the intervals associated with the different shortcuts, as determined by the processor 110, and/or the timer 180, the processor 110 instructs the speaker 160 to emit an audible sound. The sound may be a single sound used at each time interval. For example at all time intervals the speaker 160 may emit a single beep to denote the passage of another time interval. However, the speaker 160 may emit a unique sound for each time interval elapsed. For example, at time interval one a single beep may be emitted and at time interval two, two beeps may be emitted. The speaker 160 may also emit a spoken word depending on the shortcut defined to be activated at each time interval. For example, if time interval one activates a contact list, the speaker 160 may emit the sound “contact list.” If time interval two activates SMS text messaging, the speaker 160 may emit the sound “text messages.” It should be noted, however, that the MU 101 is not limited to one method of audible sound and may be a combination of the above-described methods or any other similar methods. It should be further noted that the use of an audio component is exemplary and the MU 101 may use other notification methods, such as those described below.

The MU 101 may further include a vibrating component. The vibrating component may be used to vibrate the MU 101 at the predetermined time intervals. For example at time interval one, the vibrating component may cause the MU 101 to vibrate once. At time interval two, the vibrating component may cause the MU 101 to vibrate twice. The use of the number of vibrations matching the specific time interval is exemplary, and any vibration can be used, including but not limited to, a single vibrate after each time interval or any distinguishing vibration at each interval.

The MU 101 may further include a light-emitting device, such as an LED. The light-emitting device may be used to denote the passing of each time interval. For example at time interval one, the light-emitting device may flash once. At time interval two, the light-emitting device may flash twice. The use of the number of times the light-emitting device flashes matching the specific time interval is exemplary, and any combination of flashes may be used, including but not limited to, a single flash after each time interval or any distinguishing flashing at each interval. It should be further noted that the MU 101 need not have a separate light-emitting device and may employ the display of the touch screen 130 to flash at each interval.

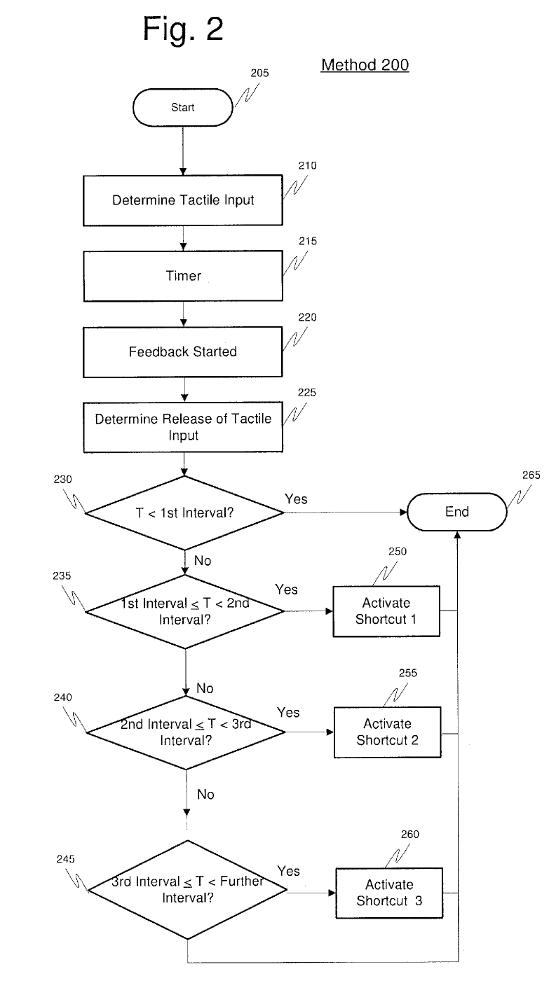

FIG. 2 shows an exemplary method 200 for determining which shortcut to be activated. The exemplary method 200 will be described with reference to the exemplary system 100 of FIG. 1. As described above, the exemplary the MU 101 may be a device such as a mobile phone. Alternatively, the exemplary embodiments of the present invention may apply to other mobile devices, such as PDAs, laptop computers, mp3 players, etc. or other stationary devices implementing a touch screen such as ATMs, building directories, etc.

In step 205, the MU 101 may initially operate in a standard mode. The MU 101 may have the display of the touch screen 130 activated prior to step 205. It should be noted, however, that the display of the touch screen 130 need not be activated and the screen of the MU 101 may be blank prior to any input in the touch screen 130. In step 210, the touch screen 130 determines a tactile input. As noted above this may be from a stylus or finger, or any combination or similar method of inputting into the touch screen 130. Further, in step 210, the touch screen 130 sends a signal to the processor 110 informing the processor 110 that an input has been detected. This input may be received at a particular location on the touch screen 130, at a preset button displayed by the touch screen 130, or at any location on the touch screen 130. In step 215, the processor 110 further communicates with the timer 180 to start a count to determine the amount of time the touch screen 130 is engaged.

In step 220, feedback, to inform the user that a time interval has passed, is started. It should be noted, however, that step 220 is optional, and feedback does not need to be provided to the user in order for the time intervals to pass. Examples of feedback may be the audible, tactile, or visual cues provided above. In step 225, the touch screen 130 determines the release of the input into the touch screen 130 and communicates with the processor 110. The processor 110 receives the signal from the touch screen 130 and further communicates with the timer 180. The timer 180 stops the count and sends the elapsed amount of time to the processor 110.

In step 230, the processor 110 compares the amount of time elapsed from the timer 180 to the predefined intervals stored in the memory 120. If the time elapsed, as per the timer 180, is less than the first predefined interval from the memory 120 then no function is performed and method 200 continues on to step 265. In step 265 the processor 110 resets the timer 180 and awaits any further input from the touch screen 130.

In step 235, the processor 110 compares the time elapsed from the timer 180 with the predefined time intervals as stored in the memory 120. If the time elapsed is greater than or equal to the first predefined interval, but less than the second predefined interval then method 200 continues on to step 250 where shortcut one is activated. As stated above, shortcut one can be any shortcut defined by the manufacturer or customized by the user or any combination of shortcuts. After shortcut one is activated method 200 continues on to step 265 whereby the processor 110 resets the timer 180 and awaits further input from the touch screen 130.

In step 240, the processor 110 compares the time elapsed from the timer 180 with the predefined time intervals as stored in the memory 120. If the time elapsed is greater than or equal to the second predefined interval, but less than the third predefined interval then method 200 continues on to step 255 where shortcut two is activated. After shortcut two is activated method 200 continues on to step 265 whereby the processor 110 resets the timer 180 and awaits further input from the touch screen 130. Similarly, in step 245, the processor 110 compares the time elapsed from the timer 180 with the predefined time intervals as stored in the memory 120. If the time elapsed is greater than or equal to the third predefined interval, but less than a further predefined interval then method 200 continues on to step 260 where shortcut three is activated. After shortcut three is activated method 200 continues on to step 265 whereby the processor 110 resets the timer 180 and awaits further input from the touch screen 130. It should be noted that while the above example uses three predefined intervals, there could be an infinite number of intervals defined and is not limited to a particular number of intervals.

In an exemplary embodiment time interval one is one second, time interval two is two seconds and time interval three is three seconds. It should be noted, however, that each time interval is not limited to one-second intervals and can be any amount of time as set by the manufacturer of the MU 101 or by the user. The time intervals can further be any combination of preset and user customized time intervals and each time may be different (e.g., time interval one may be one second, while time intervals two and three may be two seconds.

In an exemplary embodiment a shortcut may be activating SMS messaging, activating a camera option, or activating a contact list. It should be noted, however, that the shortcuts are not limited to the above examples, and the shortcut can be any function limited only by the functions available to the device. For instance, the shortcut can be activating an internet connection, disabling a ringer, or activating a speed dial.

It will be apparent to those skilled in the art that various modifications may be made in the present invention, without departing from the spirit or the scope of the invention. Thus, it is intended that the present invention cover modifications and variations of this invention provided they come within the scope of the appended claimed and their equivalents.

What is claimed is:

1. A method, comprising:
detecting an input into a touch screen;
detecting the release of the input from the touch screen;
calculating an elapsed time between the input and the release of the touch screen; and
and activating a function based on the elapsed time.

2. The method according to claim 1, wherein the function is a first shortcut that is activated when the elapsed time is greater than or equal to a first interval but less than a second interval

3. The method according to claim 2, wherein the function is a second shortcut that is activated when the elapsed time is greater than or equal to the second interval but less than a third interval.

4. The method according to claim 1, wherein the activating the function is further based on a defined plurality of time intervals, the method further comprising:
indicating a passage of each time interval.

5. The method according to claim 4, wherein the indicating includes one of an audio indication, a tactile indication, and a visual indication.

6. The method according to claim 1, further comprising:
setting the function corresponding to the elapsed time.

7. The method according to claim 4, further comprising:
setting each of the timer intervals.

8. The method according to claim 1, wherein the touch screen includes a predefined area for receiving the input.

9. The method according to claim 8, wherein the predefined area is a plurality of predefined areas and each predefined area corresponds to a pre-determined set of functions and the corresponding elapsed time.

10. A device, comprising:
a memory storing a plurality of functions and a corresponding time interval for each function;
a tactile input detecting an activation and a release;
a timer determining an elapsed amount of time between the activation and the release of the tactile input; and
a processor activating one of the plurality of functions based on the elapsed time and the corresponding time interval.

11. The device according to claim 10, further comprising:
an indicator that indicates the passage of a time interval.

12. The device according to claim 11, wherein the indicator is one of an audio component, a tactile feedback component, and a visual feedback component.

13. The device according to claim 10, wherein the functions are preset by one of a manufacturer and a user.

14. The device according to claim 10, wherein the time intervals are defined by at least one of a manufacturer and a user.

15. The device according to claim 10, wherein the tactile input is a touch screen.

16. The device according to claim 15, wherein the touch screen displays one or more buttons and the activation is an engaging of the portion of the touch screen corresponding to the one or more buttons.

17. The device according to claim 15, wherein the touch screen includes a plurality of portions, each portion corresponding to a defined set of the plurality of functions and corresponding time intervals.

18. The device according to claim 15, wherein the touch screen is one of a contact touch screen and a heat sensitive touch screen.

19. The device according to claim 10, wherein the processor resets the timer after activating the one of the functions.

20. A system, comprising:
a memory means for storing a plurality of functions and corresponding time intervals.
a tactile means for detecting the activation of a tactile input;
a timer means for determining the elapsed amount of time the tactile input is activated; and
a processor means for activating one of the plurality of functions based on the elapsed time and the corresponding time interval.
